(19) United States
(12) Patent Application Publication
(10) Pub. No.: US 2026/0365239 A1
(43) Pub. Date: Nov. 19, 2026

(54) STEERING OF AN ELECTRIC COUNTER-BALANCE TRUCK

(71) Applicant: Mitsubishi Logisnext Europe Oy, Järvenpää (FI)

(72) Inventor: Janne Laaksonen, Riihimäki (FI)

(73) Assignee: Mitsubishi Logisnext Europe Oy, Järvenpää (FI)

(21) Appl. No.: 19/148,363

(22) PCT Filed: Dec. 5, 2023
(86) PCT No.: PCT/FI2023/050662

§ 371 Date: Jul. 16, 2025

(30) Foreign Application Priority Data
Jan. 17, 2023 (FI) 20235043

(51) Int. Cl. B62D 11/04; B60L 15/20; B62D 15/02; B66F 9/075

(52) U.S. Cl. CPC B62D 11/04; B60L 15/20; B62D 15/021; B66F 9/07568; B60L 2200/42; B60L 2240/423; B60L 2240/463

(57) ABSTRACT

A method for controlling of at least two traction motors (160) of an electric counter-balance truck (100) is provided, the method comprises: determining (310) a steering angle (α) of the electric counter-balance truck (100); determining (320) at least one parameter descriptive of a steering; generating (330) traction motor setpoints individually to each of the at least two traction motors (160) based on the steering angle and the at least one parameter descriptive of a steering; and generating (340) control signals individually to each of the at least two traction motors (160) for controlling of the at least two traction motors (160) of an electric counter-balance truck (100) to generate torques in accordance with the traction motor setpoints Also a control unit, a computer program and an electric counter-balance truck are provided to.

### TECHNICAL FIELD

The invention concerns in general the technical field of electric counter-balance trucks. More particularly, the invention concerns a steering of an electric counter-balance truck.

### BACKGROUND

Steering of vehicle, in general, is an important aspect for an operation of the vehicle in question. The steering of the vehicle is especially important in environments where there is a limited amount of space and a speed of operation plays an important role e.g. in a form of an efficiency. This kind of situation is with counter-balance trucks which typically operate in warehouses and warehouse areas.

According to a state of the art the steering of electric counter-balance trucks, such as the one schematically illustrated in FIG. 1, is arranged so that there is a number of steered wheels 110 in a rear-side of the truck 100 and two or more driving wheels 120 in a front-side of the truck 100. The steered wheels 110 may be mounted on a common rear axle which is steerable from a rotating steering wheel 130, such as from a steering wheel, by an operator of the electric counter-balance truck 100. A steering angle α of the truck 100 may be measured in a various manner, such as with a sensor 140 positioned to an applicable position to provide measurement data descriptive of the steering angle α. The steering angle sensor 140 may e.g. be associated to an applicable position of a rear axle 115, such as to a pivoted axle of one of the steered wheels or it may be mechanically linked to between the steered wheels 110 or integrated to respective hydraulic cylinder through which the steering force is brought to the respective axle. As non-limiting examples of applicable sensor types may be mentioned an angle sensor and a linear motion sensor. Measurement data from the sensor 140 may be provided to a control unit 150. The control unit 150 may be provided with a computer model of the truck geometry by means of which the control unit 150 may be arranged to generate data on a state of the electric counter-balance truck 100 e.g. during a motion of the electric counter-balance truck 100. The computer model may e.g. receive the steering angle α of the truck 100 as an input and compute further instructions to control the motion of the electric counter-balance truck 100. For example, the control unit 150 may generate control signals to traction motors 160 of the drive wheels 120 which motors 160 may be independently controllable e.g. with so called speed orders in order to generate individual traction force to the respective drive wheels 120. In the prior art solutions the setpoint of the traction motors 160, i.e. the speed order ratio between the traction motors 160, follows the actual value of the steering angle α of the truck 100 obtained from the rear axle sensor 140.

The prior art solution has various drawbacks which become present e.g. in fast turns and/or turns initiated to opposite direction into which the truck is already turning to due to inertia of the rear axle 115. In other words, the truck 100 experiences remarkable steering delay because the steering achieved with the traction motors 160 in the front of the truck 100 and having larger impact in dynamically affecting to a travel direction of the truck 100 aims to steer in accordance with the real steering angle determined e.g. from the rear axle 115, but not in accordance with an intention of the operator of the truck 100. In practice, the above described situation becomes visible, or tangible, as an additional worn, or damage, in the rear wheels, less agile operation, but also as a reduced feel in steering.

Hence, there is need to develop solutions improving a steering of a counter-balance truck and/or mitigating, at least in part, the above-mentioned drawbacks of the prior art solution.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control unit, a computer program and an electric counter-balance truck for controlling of at least two traction motors of an electric counter-balance truck.

The objects of the invention are reached by a method, a control unit, a computer program and an electric counter-balance truck as defined by the respective independent claims.

According to a first aspect, a method for controlling of at least two traction motors of an electric counter-balance truck is provided, each of the at least two traction motors independently controllable and arranged to generate a torque to a respective at least one drive wheel, the method, performed by a control unit of the electric counter-balance truck, comprises:
determining a steering angle of the electric counter-balance truck,
determining at least one parameter descriptive of a steering received from a rotating steering wheel of the electric counter-balance truck,
generating traction motor setpoints individually to each of the at least two traction motors based on the steering angle of the electric counter-balance truck and the at least one parameter descriptive of a steering from a rotating steering wheel of the electric counter-balance truck, and
generating control signals individually to each of the at least two traction motors for controlling of the at least two traction motors of an electric counter-balance truck to generate torques in accordance with the traction motor setpoints.

For example, the steering angle may be determined based on measurement data received from at least one of the following: a steering angle sensor mounted to the rear axle of the electric counter-balance truck; a sensor arranged to measure an operating state of at least one hydraulic cylinder controlling a steering angle of the rear axle of the electric counter-balance truck; a sensor mounted to an axle of a motor measuring a steering angle of at least one steered wheel.

Moreover, the at least one parameter descriptive of the steering may be a steering angle of the rotating steering wheel. The steering angle of the rotating steering wheel may e.g. be determined based on measurement data received from a sensor being a steering wheel angle sensor.

The generation of the traction motor setpoints based on the steering angle of the electric counter-balance truck and the at least one parameter descriptive of the steering from a rotating steering wheel of the electric counter-balance truck may e.g. performed by dynamically weighting the steering angle of the electric counter-balance truck between the steering angle and the steering angle of the rotating steering wheel.

Alternatively, the at least one parameter descriptive of the steering may be a rotation direction of the rotating steering wheel and a rotation speed of the rotating steering wheel. For example, the rotation direction of the rotating steering wheel and the rotation speed of the rotating steering wheel may be determined based on data received from a sensor being a steering wheel incremental encoder.

The generation of the traction motor setpoints based on the steering angle of the rear axle of the electric counter-balance truck and the at least one parameter descriptive of the steering from a rotating steering wheel of the electric counter-balance truck may be performed by dynamically determining a variable offset to the steering angle of the electric counter-balance truck based on the steering angle and the steering angle of the rotating steering wheel.

In accordance with above, the generation of the control signals individually to each of the at least two traction motors may comprise a determination of individual speed orders for the each of the at least two traction motors in accordance with the traction motor setpoints.

According to a second aspect, a control unit for controlling of at least two traction motors of an electric counter-balance truck is provided, each of the at least two traction motors independently controllable and arranged to generate a torque to a respective at least one drive wheel, the control unit is configured to:
determine a steering angle of the electric counter-balance truck,
determine at least one parameter descriptive of a steering received from a rotating steering wheel of the electric counter-balance truck,
generate traction motor setpoints individually to each of the at least two traction motors based on the steering angle of the electric counter-balance truck and the at least one parameter descriptive of a steering from a rotating steering wheel of the electric counter-balance truck, and
generate control signals individually to each of the at least two traction motors for controlling of the at least two traction motors of the electric counter-balance truck to generate torques in accordance with the traction motor setpoints.

The control unit may be configured to determine the steering angle based on measurement data received from at least one of the following: a steering angle sensor mounted to the rear axle of the electric counter-balance truck; a sensor arranged to measure an operating state of at least one hydraulic cylinder controlling a steering angle of the rear axle of the electric counter-balance truck; a sensor mounted to an axle of a motor measuring a steering angle of at least one steered wheel.

The control unit may be arranged to apply a steering angle of the rotating steering wheel as the at least one parameter descriptive of the steering. For example, the control unit may be configured to determine the steering angle of the rotating steering wheel based on measurement data received from a sensor being a steering wheel angle sensor.

The control unit may be configured to generate the traction motor setpoints based on the steering angle of the electric counter-balance truck and the at least one parameter descriptive of the steering from a rotating steering wheel of the electric counter-balance truck by dynamically weighting the steering angle of the electric counter-balance truck between the steering angle and the steering angle of the rotating steering wheel.

Alternatively, the control unit may be arranged to apply a rotation direction of the rotating steering wheel and a rotation speed of the rotating steering wheel as the at least one parameter descriptive of the steering. For example, the control unit may be configured to determine the rotation direction of the rotating steering wheel and the rotation speed of the rotating steering wheel based on data received from a sensor being a steering wheel incremental encoder.

The control unit may be configured to generate the traction motor setpoints based on the steering angle of the rear axle of the electric counter-balance truck and the at least one parameter descriptive of the steering from a rotating steering wheel of the electric counter-balance truck by dynamically determining a variable offset to the steering angle of the electric counter-balance truck based on the steering angle and the steering angle of the rotating steering wheel.

In accordance with above, the control unit may be configured to generate the control signals individually to each of the at least two traction motors by determining individual speed orders for the each of the at least two traction motors in accordance with the traction motor setpoints.

According to a third aspect, a computer program is provided, the computer program comprising instructions to cause the control unit according to the second aspect as defined above to execute the steps of the method according to the first aspect as defined above.

According to a fourth aspect, an electric counter-balance truck is provided, the electric counter-balance truck comprising the control unit according to the second aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a counter-balance truck according to an example.

FIG. 2 illustrates schematically a steering of a counter-balance truck according to an example.

FIG. 3 illustrates schematically a method according to an example.

FIG. 4 illustrates schematically a control unit according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

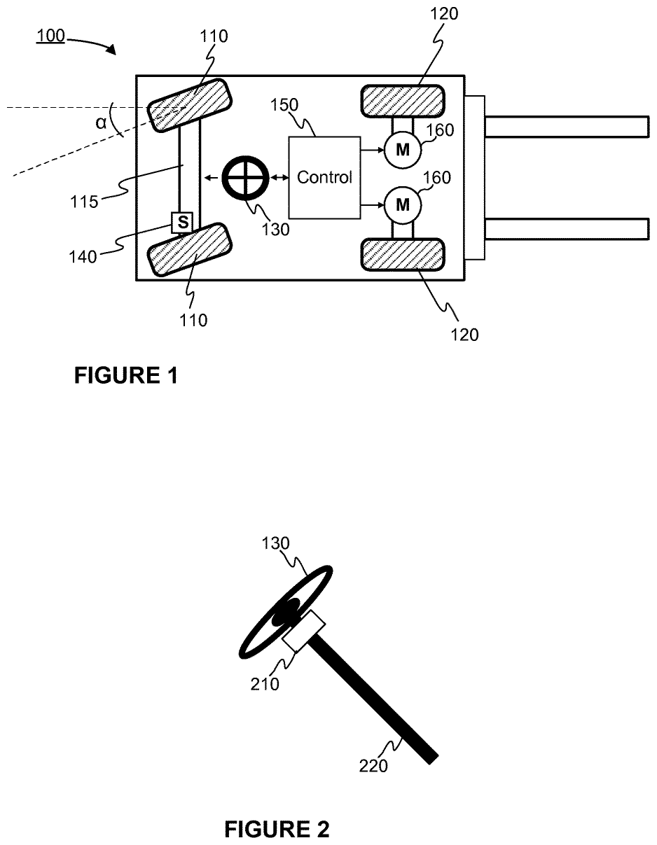

The present invention may be implemented in an electric counter-balance truck. In the forthcoming description of the present invention the electric counter-balance truck as schematically illustrated in FIG. 1 is referred to. For avoidance of any doubts the electric counter-balance truck 100 may comprise one or more steered wheels 110, e.g. mounted on the same rear axle 115 which is steerable with a rotating steering wheel 130. As is clear, the number of steered wheels 110 in the non-limiting example of FIG. 1 is two. The rotating steering wheel 130 may refer to a device which is allowed to turn in an unlimited manner, i.e. being so called endlessly rotating steering device, or the rotation may be limited to certain extremities. For sake of clarity it is worthwhile to mention that the term “rotating steering wheel” does not take any standpoint with respect to an appearance of the respective device, but only to that the steering is performed with a rotational movement of the steering device, i.e. the rotation steering wheel 130. The steering may be implemented as an electric steering or electrohydraulic steering. The electric steering represents a solution where steering wheel does not have physical connection to the steering system. In other words, the rotating steering wheel 130 has only at least one redundant sensor which monitors the steering wheel absolute position. This position is then measured by a respective controller, such as a steering controller, which then generates control signals to control one or more individual steering motor(s). This steering motor can be either connected directly to the number of steered wheels 110, or it can be used to give pressure to the hydraulic steering system. The electrohydraulic steering, in turn, represents a solution in which the rotating steering wheel 130 is provided with a mechanical/hydraulic connection to the steering system via orbital. The orbital may be pressurized from a main hydraulic pump via a priority valve or an individual steering hydraulic pump. The orbital transfers a movement of the rotating steering wheel 130 to an oil flow which then turns the steered wheel(s) 110. In the electrohydraulic steering, the rotating steering wheel may be provided with an absolute or an incremental sensor, and the steered wheel(s) may be provided with a sensor measuring absolute position. Both the electrical steering system and the electrohydraulic steering system are generally known as such.

In accordance with the present invention a control unit 150 may receive information with respect to the steering with the rotating steering wheel 130 in a manner as is described in the forthcoming description. For example, the rotating steering wheel 130 may be equipped with a sensor configured to generate measurement data descriptive of a steering received from the rotating steering wheel 130. FIG. 2 illustrates schematically an example of an implementation in which a sensor 210 is mounted to a steering shaft 220 in order to generate measurement data descriptive of the rotation angle of the rotating steering wheel 130. The sensor 210 may be understood as a steering wheel angle sensor e.g. when the steering system implemented electrically. In case the steering system is implemented with an electrohydraulic steering solution a steering wheel incremental encoder may be understood as a sensor 210 configured to generate data, i.e. one or more parameters, descriptive of the steering. More specifically, the incremental encoder associated to the steering wheel converts angular motion and/or position of a steering shaft into an analog or digital code to identify position and/or motion. Thus, the respective sensor 210, or sensors, are such that they generate measurement data from which at least one parameter descriptive of the steering given from the rotating steering wheel 130 by the operator of the electric counter-balance truck 100 may be derived in a manner as is described in the forthcoming description.

Moreover, the control unit 150 may receive information on the steering angle a of the one or more steered wheels 110 wherein the steering angle α may refer to an angle between a turning angle of the steered wheel 110 and a reference angle, such as an angle defined by a direction of the drive wheel 120 as shown in FIG. 1. The control unit 150 may also generate control signals individually to the traction motors 160 among other tasks in a manner as is described in the forthcoming description. For sake of completeness it is worthwhile to mention that the control unit 150 may be implemented as a computing device configured to serve the traction motors 160 or it may consist of a plurality of control units configured to perform the computing in a distributed manner, such as a master control unit arranged to cooperate with one or more slave computing units, such as dedicated controllers of the traction motors 160. In addition to the description given with respect to the electric counter-balance truck 100 so far it is worthwhile to mention that the electric counter-balance truck 100 may be equipped with an applicable tool, such as a fork tool, to move, such as to lift and to carry, a load.

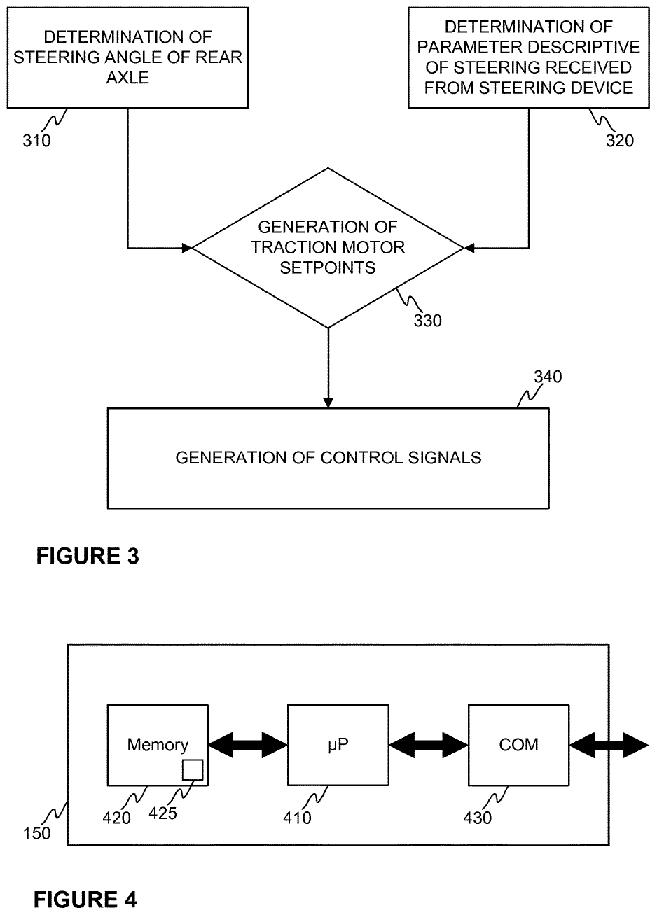

Next, further aspects in relation to the invention are described by referring to FIG. 3. FIG. 3 illustrates schematically an example of a method, executed by a control unit 150 of an electric counter-balance truck 100, for executing a steering of an electric counter-balance truck 100 by controlling of at least two traction motors 160 of the electric counter-balance truck 100. The traction motors 160 controlled in the present invention are such that they generate torques to different drive wheels 120 in the frontside of the electric counter-balance truck 100 and, thus, cause a turning effect of the electric counter-balance truck 100. In other words, each of the at least two traction motors 160 are independently controllable and arranged to generate torques to a respective at least one drive wheel. For sake of clarity it is worthwhile to mention that each traction motor 160 may generate the torque to one or more drive wheels 120 mounted to the same axle controlled by the respective motor 160. The controlling of the traction motors 160 is executed by the control unit 150 configured to run a computer program causing the controlling of the steering in the manner as described in the following.

The method comprises a step in which the control unit 150 determines 310 a parameter descriptive of a steering angle α of the electric counter-balance truck 100. The determination 310 of the steering angle α of the counter-balance truck 100 may be based on data received from a sensor 140 mounted in a predefined position suitable for providing data descriptive of the steering experienced by the at least one steered wheel 110. For example, the sensor 140 may be mounted to a rear axle of the electric counter-balance truck 100 or to an axle of a motor providing a steering force to the axle of the steered wheel(s) 110 or the sensor 140 may be integrated to a respective hydraulic cylinder through which the steering force is brought to the respective axle from the motor. In other words, the respective sensor 140 is configured to measure a parameter based on which the steering angle α may be derived. Thus, the parameter determinable from the measurement data may e.g. directly be the steering angle α if the sensor directly generates such measurement data, but any other suitable data may also be applied to.

Moreover, the control unit 150 also determines 320 a parameter descriptive of the steering received from a rotating steering wheel 130 of the electric counter-balance truck 100. In other words, since the operator of the electric counter-balance truck 100 gives steering orders with the rotating steering wheel 130 the control unit 150 is arranged to receive data descriptive of the steering, and the control unit 150 determines 320 at least one parameter descriptive of the steering from the received data. The data received by the control unit 150 may e.g. be measurement data descriptive of a steering received from a sensor 210, also callable e.g. as a steering wheel sensor. The sensor 210 may e.g. be a steering wheel angle sensor e.g. configured to provide absolute angle values descriptive on a state of rotation of the rotating steering wheel 130. The steering wheel angle sensor is e.g. applicable in the context of electric steering system. The data may also be received from a steering wheel incremental sensor e.g. in the context of an electrohydraulic steering system. Then the data may be descriptive of a rotation direction of the rotating steering wheel 130 and speed as parameters descriptive of the steering. The control unit 150 may be configured to determine the steering order, i.e. the steering angle of the rotating steering wheel 130, based on the data, such as the rotation direction of the rotating steering wheel 130 and the rotation speed, received from the steering wheel sensor e.g. by applying the data to a computer model of the electric counter-balance truck 100 which provides applicable data descriptive of the steering.

The determinations in the steps referred with 310 and 320 are performed simultaneously in time, or at least within a predefined time window from each other, to make the determined parameters comparable to each other. In other words, the aim is to receive data descriptive of the same situation within the predefined range during a motion of the electric counter-balance truck 100. For sake of completeness, the execution of the method, i.e. the determinations 310, 320 as well as the other steps of the method, may be continuous, or conducted at a certain situations, such as when the electric counter-balance truck 100 is moving to certain direction, i.e. such as to a direction in which the drive wheels 120 are heading to the travel direction before the steered wheels 110. However, it is worthwhile to mention that an application of the invention as such is not limited to a movement of the electric counter-balance truck 100 only to a certain direction, but it works in both directions of movement.

In the step 330 of FIG. 3 the control unit 150 is configured to generate 330 traction motor setpoints individually to each of the at least two traction motors 160 based on the steering angle α of the electric counter-balance truck 100 and the at least one parameter descriptive of a steering from a rotating steering wheel 130 of the electric counter-balance truck 100. In other words, the setpoint is defined for each traction motor 160 individually and separately and the setpoint values for each traction motor 160 may be the same or differ from each other or be any combination of these two. Thus, in the step 330 the aim is to determine a so-called virtual steering angle setpoint into which the traction motor setpoints are matched to.

In accordance with an embodiment of the invention wherein the parameter descriptive of the steering corresponds to a steering wheel absolute angle the traction motor setpoints may be generated 330 by dynamically weighting the steering angle α of the electric counter-balance truck 100 between the steering angle α received e.g. from the rear axle sensor 140 and the steering wheel setpoint, i.e. the steering angle of the rotating steering wheel 130, measured e.g. with the steering wheel angle sensor. In at least some example embodiments, the dynamical weighting may be mathematically performed so that the values are provided with respective weights. Thus, the traction motor setpoints may correspond only to the steering angle α, or only to the steering of the rotating steering wheel 130, or the generation of the traction motor setpoints may be based on any ratio of the mentioned values, i.e. the steering angle α and the steering of the rotating steering wheel 130 are differently weighted. The mechanism to generate 330 the traction motor setpoints is applicable in implementations in which the steering is electrical due to a fact that the steering wheel absolute angle is directly obtainable from the implementation. In the described manner the steering angle α is modified for generating the traction motor setpoints.

Correspondingly, in another embodiment of the invention wherein the parameter descriptive of the steering comprises at least data descriptive of the rotation direction and rotation speed of the rotating steering wheel 130 the traction motor setpoints may be generated 330 by dynamically determining a variable offset to the actual steering angle α of the electric counter-balance truck 100 based on the rotation direction of the rotating steering wheel 130 and the rotation speed of the steering wheel 130, i.e. based on the data obtained from the encoder as described. For the system fail-safe functionality, the offset may be provided with a predefined safety margin which the system is not allowed to override, as well the rotating steering wheel 130 may be provided with a maximum turning speed which system is not allowed to override. As a result, the steering angle α of the electric counter-balance truck 100 may be averaged between the actual angle received e.g. from the rear axle sensor 140 and the steering wheel setpoint. The mechanism to generate 330 the traction motor setpoints according to the other embodiment is applicable in implementations in which the steering is electrohydraulic due to a fact that the parameters descriptive of the steering are obtainable from the encoder as described, which is a device used as a sensor in the context of the electrohydraulic steering.

The present invention as supported by the embodiments in relation to the step 330 and as discussed in the foregoing description are advantageous in a sense that they modify the input used for generating the control signals for the traction motors 160, i.e. the traction motor setpoints. Thus, in response to the generation of the traction motor setpoints in the above described way the control unit 150 is configured to generate 340 control signals individually to each of the at least two traction motors 160. The generation 340 of the individual control signals to the traction motors 160 by the control unit 150 is performed for controlling of the at least two traction motors 160 of the electric counter-balance truck 100 to generate torques in accordance with the traction motor setpoints as generated in the prior steps of the method. The control unit 150 may e.g. generate speed orders to the respective traction motors 160 so that the generated speed orders comply with the traction motor setpoints.

The method as described may be executed by the control unit 150 as described. A non-limiting example of a computing entity corresponding to the control unit 150 is schematically illustrated in FIG. 4. In other words, the apparatus of FIG. 4 may be configured to perform a function to control a steering of the electric counter-balance truck 100 by generating the control signals. For sake of clarity, it is worthwhile to mention that the block diagram of FIG. 4 depicts only some components of an entity that may be employed to implement a functionality of the apparatus.

The non-limiting example of the apparatus according to FIG. 4 comprises a processor 410 and a memory 420. The memory 420 may store data, such as pieces of data as described, but also a computer program 425 implemented with a computer program code causing the controlling of the steering in the described manner when executed. The apparatus may further comprise a communication interface 430, such as a wireless communication interface or a communication interface for wired communication, or both to communicate with other entities. The communication interface 430 may thus comprise one or more modems, antennas, and any other hardware and software for enabling an execution of the communication e.g. under control of the processor 410. Furthermore, I/O (input/output) components may be arranged, together with the processor 410 and a portion of the computer program code 425, to provide a user interface for receiving input from a user, such as from an operator of the electric counter-balance truck 100, and/or providing output to the operator when necessary. In particular, the user I/O components may include user input means, such as one or more keys or buttons, a keyboard, a touchscreen, or a touchpad, and especially the rotating steering wheel 130, etc. The user I/O components may include output means, such as a loudspeaker, a display, or a touchscreen. The components of the apparatus may be communicatively connected to each other via data bus that enables transfer of data and control information between the components.

The memory 420 and at least a portion of the computer program 425 stored therein may further be arranged, with the processor 410, to cause the apparatus to perform at least a portion of a method as is described. The processor 410 may be configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some, or all of which may be integrated/removable and/or may provide permanent/semi-permanent/dynamic/cached storage.

The computer program code 425 may comprise computer-executable instructions that implement functions that correspond to steps implemented in the method when loaded into the processor 410 of the respective control unit 150. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus to perform a method as described. Hence, the apparatus may comprise at least one processor 410 and at least one memory 420 including the computer program 425 for one or more programs, the at least one memory 420 and the computer program 425 configured to, with the at least one processor 410, cause the apparatus implementing the control unit 150 to perform the method.

The computer program 425 may be provided e.g. a computer program product comprising at least one computer-readable non-transitory medium having the computer program code stored thereon, which computer program 425, when executed by the processor 410, causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program 425 may comprise a proprietary application, such as computer program code, for causing an execution of the method in the manner as described in the description herein.

Any of the programmed functions mentioned may also be performed in firmware or hardware adapted to or programmed to perform the necessary tasks.

For sake of completeness it is worthwhile to mention that the entity configured to perform the method in the role of the control unit 150 may also be implemented with a plurality of apparatuses, such as the one schematically illustrated in FIG. 4, as a distributed computing environment corresponding to a control unit. For example, one of the apparatuses may be communicatively connected with the other apparatuses, and e.g. share the data of the method, to cause another apparatus to perform at least one other portion of the method. As a result, the method performed in the distributed computing environment generates the control signal indicative of the assignment of the responsibility as described. For example, some steps of the method may be shared between a master control unit and one or more slave control units, for example.

As directly derivable from above the control unit 150 may be considered to correspond to a computing device, or a plurality of computing devices, configured to run a computer program implementing the method steps as described.

As is clear some aspects of the invention relate to a computer program comprising computer program code which, when executed by a processor, cause the control unit to perform the method as described.

The aspects of the invention are hereby described by indicating that the invention is applicable in an electric counter-balance truck 100. In the context of the present invention the term shall be understood to refer to a counter-balance truck 100 having an arrangement in which a plurality of drive wheels are provided with own dedicated traction motors to provide the torque for the respective drive wheels e.g. in a manner as shown in FIG. 1. The traction motors are individually controllable so as to cause the effect in accordance with the present invention.

To conclude it may be said that the present invention provides a solution in which the traditional rear axle based steering is converted to an active steering in which independent speed control of traction motors is actively arranged to participate in the steering of the electric counter-balance truck to a desired direction instead of only following the rear axle. The invention provides a number of advantages over the prior art solutions. Namely, the invention provides a safer operation of the electric counter-balance truck 100 due faster overall steering response time compared to prior art solutions. The invention also brings a more stable drivability of the electric counter-balance truck 100 when changing a turning angle of the electric counter-balance truck 100, especially in slippery conditions. Still further, a more agile truck operation and reduced rear tire wear are gained with the present invention.

The specific examples provided in the description given above should not be construed as limiting the applicability and/or the interpretation of the appended claims. Lists and groups of examples provided in the description given above are not exhaustive unless otherwise explicitly stated.

1. A method for controlling of at least two traction motors of an electric counter-balance truck, each of the at least two traction motors independently controllable and arranged to generate a torque to a respective at least one drive wheel, the method, performed by a control unit of the electric counter-balance truck, comprises:
determining a steering angle of the electric counter-balance truck,
determining at least one parameter descriptive of a steering received from a rotating steering wheel of the electric counter-balance truck,
generating traction motor setpoints individually to each of the at least two traction motors based on the steering angle of the electric counter-balance truck and the at least one parameter descriptive of a steering from a rotating steering wheel of the electric counter-balance truck, and
generating control signals individually to each of the at least two traction motors for controlling of the at least two traction motors of the electric counter-balance truck to generate torques in accordance with the traction motor setpoints.

2. The method according to claim 1, wherein the steering angle is determined based on measurement data received from at least one of the following:
a steering angle sensor mounted to the rear axle of the electric counter-balance truck;
a sensor arranged to measure an operating state of at least one hydraulic cylinder controlling a steering angle of the rear axle of the electric counter-balance truck;
a sensor mounted to an axle of a motor measuring a steering angle of at least one steered wheel.

3. The method according to claim 1, wherein the at least one parameter descriptive of the steering is a steering angle of the rotating steering wheel.

4. The method according to claim 3, wherein the steering angle of the rotating steering wheel is determined based on measurement data received from a sensor being a steering wheel angle sensor.

5. The method according to claim 3, wherein the generation of the traction motor setpoints based on the steering angle of the electric counter-balance truck and the at least one parameter descriptive of the steering from a rotating steering wheel of the electric counter-balance truck is performed by dynamically weighting the steering angle of the electric counter-balance truck between the steering angle and the steering angle of the rotating steering wheel.

6. The method according to claim 1, wherein the at least one parameter descriptive of the steering is a rotation direction of the rotating steering wheel and a rotation speed of the rotating steering wheel.

7. The method according to claim 6, wherein the rotation direction of the rotating steering wheel and the rotation speed of the rotating steering wheel are determined based on data received from a sensor being a steering wheel incremental encoder.

8. The method according to claim 6, wherein the generation of the traction motor setpoints based on the steering angle of the rear axle of the electric counter-balance truck and the at least one parameter descriptive of the steering from a rotating steering wheel of the electric counter-balance truck is performed by dynamically determining a variable offset to the steering angle of the electric counter-balance truck based on the steering angle and the steering angle of the rotating steering wheel.

9. The method according to claim 1, wherein the generation of the control signals individually to each of the at least two traction motors comprises a determination of individual speed orders for the each of the at least two traction motors in accordance with the traction motor setpoints.

10. A control unit for controlling of at least two traction motors of an electric counter-balance truck, each of the at least two traction motors independently controllable and arranged to generate a torque to a respective at least one drive wheel, the control unit is configured to:
determine a steering angle of the electric counter-balance truck,
determine at least one parameter descriptive of a steering received from a rotating steering wheel of the electric counter-balance truck,
generate traction motor setpoints individually to each of the at least two traction motors based on the steering angle of the electric counter-balance truck and the at least one parameter descriptive of a steering from a rotating steering wheel of the electric counter-balance truck, and
generate control signals individually to each of the at least two traction motors for controlling of the at least two traction motors of the electric counter-balance truck to generate torques in accordance with the traction motor setpoints.

11. The control unit according to claim 10, wherein the control unit is configured to determine the steering angle based on measurement data received from at least one of the following: a steering angle sensor mounted to the rear axle of the electric counter-balance truck; a sensor arranged to measure an operating state of at least one hydraulic cylinder controlling a steering angle of the rear axle of the electric counter-balance truck; a sensor mounted to an ax-le of a motor measuring a steering angle of at least one steered wheel.

12. The control unit according to claim 10, wherein the control unit is arranged to apply a steering angle of the rotating steering wheel as the at least one parameter descriptive of the steering.

13. The control unit (150) according to claim 12, wherein the control unit (150) is configured to determine (320) the steering angle of the rotating steering wheel (130) based on measurement data received from a sensor (210) being a steering wheel angle sensor.

14. The control unit according to claim 12, wherein the control unit is configured to generate the traction motor setpoints based on the steering angle of the electric counter-balance truck and the at least one parameter descriptive of the steering from a rotating steering wheel of the electric counter-balance truck by dynamically weighting the steering angle of the electric counter-balance truck between the steering angle and the steering angle of the rotating steering wheel.

15. The control unit according to claim 10, wherein the control unit is arranged to apply a rotation direction of the rotating steering wheel and a rotation speed of the rotating steering wheel as the at least one parameter descriptive of the steering.

16. The control unit according to claim 15, wherein the control unit is configured to determine the rotation direction of the rotating steering wheel and the rotation speed of the rotating steering wheel based on data received from a sensor being a steering wheel incremental encoder.

17. The control unit (150) according to claim 15, wherein the control unit is configured to generate the traction motor setpoints based on the steering angle of the rear axle of the electric counter-balance truck and the at least one parameter descriptive of the steering from a rotating steering wheel of the electric counter-balance truck by dynamically determining a variable offset to the steering angle of the electric counter-balance truck based on the steering angle and the steering angle of the rotating steering wheel.

18. The control unit according to claim 10, wherein the control unit is configured to generate the control signals individually to each of the at least two traction motors by determining individual speed orders for the each of the at least two traction motors in accordance with the traction motor setpoints.

19. A computer program for controlling of at least two traction motors of an electric counter-balance truck, each of the at least two traction motors independently controllable and arranged to generate a torque to a respective at least one drive wheel which, when executed by at least one processor of a control unit, cause the control unit to perform:
determining a steering angle of the electric counter-balance truck,
determining at least one parameter descriptive of a steering received from a rotating steering wheel of the electric counter-balance truck,
generating traction motor setpoints individually to each of the at least two traction motors based on the steering angle of the electric counter-balance truck and the at least one parameter descriptive of a steering from a rotating steering wheel of the electric counter-balance truck, and
generating control signals individually to each of the at least two traction motors for controlling of the at least two traction motors of the electric counter-balance truck to generate torques in accordance with the traction motor setpoints.

20. An electric counter-balance truck comprising a control unit configured to:
determine a steering angle of the electric counter-balance truck,
determine at least one parameter descriptive of a steering received from a rotating steering wheel of the electric counter-balance truck,
generate traction motor setpoints individually to each of the at least two traction motors based on the steering angle of the electric counter-balance truck and the at least one parameter descriptive of a steering from a rotating steering wheel of the electric counter-balance truck, and
generate control signals individually to each of the at least two traction motors for controlling of the at least two traction motors of the electric counter-balance truck to generate torques in accordance with the traction motor set-points.
